(19) United States
(12) Patent Application Publication
(10) Pub. No.: US 2020/0347155 A1
(43) Pub. Date: Nov. 5, 2020

(54) PROCESS FOR PRODUCING HYDROPHOBICALLY ASSOCIATING POLYACRYLAMIDES

(71) Applicant: BASF SE, Ludwigshafen am Rhein (DE)

(72) Inventors: Tobias Joachim ZIMMERMANN, Ludwigshafen am Rhein (DE); Michael SINZINGER, Trostberg (DE); Mirjam SCHWARZ, Trostberg (DE); Veronika ERL, Trostberg (DE); Alexander KRONAST, Trostberg (DE)

(21) Appl. No.: 16/759,141

(22) PCT Filed: Oct. 18, 2018
(86) PCT No.: PCT/EP2018/078503

§ 371 Date: Apr. 24, 2020

(30) Foreign Application Priority Data
Oct. 25, 2017 (EP) 17198243.2

(51) Int. Cl. C08F 2/10; C08F 220/58; C08F 220/56; C08F 216/14; C09K 8/68; C09K 8/88; C09K 8/588

(52) U.S. Cl. CPC C08F 2/10; C08F 220/58; C08F 220/56; C09K 8/588; C09K 8/68; C09K 8/885; C08F 216/1425

(57) ABSTRACT

Process for producing hydrophobically associating polyacrylamides Summary Process of manufacturing hydrophobically associating polyacrylamides comprising at least acrylamide or derivatives thereof and an associative monomer by adiabatic gel polymerization of an aqueous monomer solution, wherein the concentration of the monomers in the aqueous solution is from 1 mole/kg to 3.3 mole/kg, relating to the total of all components of the aqueous monomer solution. The process yields hydrophobically associating polyacrylamides having an improved viscosity efficiency. Hydrophobically associating polyacrylamides obtainable by the process of the present invention and use of such hydrophobically associating polyacrylamides for oilfield applications, in particular for enhanced oil recovery, conformance control and hydraulic fracturing.

The invention relates to a process of manufacturing hydrophobically associating polyacrylamides comprising at least acrylamide or derivatives thereof and an associative monomer by adiabatic gel polymerization of an aqueous monomer solution, wherein the concentration of the monomers in the aqueous solution is from 1 mole/kg to 3.3 mole/kg, relating to the total of all components of the aqueous monomer solution. The process yields hydrophobically associating polyacrylamides having an improved viscosity efficiency. The invention also relates to hydrophobically associating polyacrylamides obtainable by the process of the present invention and to the use of such hydrophobically associating polyacrylamides for oilfield applications, in particular enhanced oil recovery, conformance control and hydraulic fracturing.

Aqueous solutions of water-soluble, high molecular weight homo- and copolymers of acrylamide may be used for various applications such as mining and oilfield applications, water treatment, sewage treatment, papermaking, and agriculture. Examples include its use in the exploration and production of mineral oil, in particular as thickener in aqueous injection fluids for enhanced oil recovery or as rheology modifier for aqueous drilling fluids. Further examples include its use as flocculating agent for tailings and slurries in mining activities.

The techniques of enhanced oil recovery include what is called “polymer flooding”. Polymer flooding involves injecting an aqueous solution of a thickening polymer into the mineral oil deposit through the injection wells, the viscosity of the aqueous polymer solution being matched to the viscosity of the mineral oil. Through the injection of the polymer solution, the mineral oil, as in the case of water flooding, is forced through said cavities in the formation from the injection well proceeding in the direction of the production well, and the mineral oil is produced through the production well. By virtue of the polymer formulation having about the same viscosity as the mineral oil, the risk that the polymer formation will break through to the production well with no effect is reduced. Thus, the mineral oil is mobilized much more homogeneously than when water, which is mobile, is used, and additional mineral oil can be mobilized in the formation. Details of polymer flooding and of polymers suitable for this purpose are disclosed, for example, in “Petroleum, Enhanced Oil Recovery, Kirk-Othmer, Encyclopedia of Chemical Technology, Online Edition, John Wiley & Sons, 2010”

A known method is to use hydrophobically associating copolymers for polymer flooding. “Hydrophobically associating copolymers” are understood by a person skilled in the art to mean water-soluble copolymers which, as well as hydrophilic units (in a sufficient amount to assure water solubility), have hydrophobic groups in lateral or terminal positions. In aqueous solution, the hydrophobic groups can associate with one another. Because of this associative interaction, there is an increase in the viscosity of the aqueous polymer solution compared to a polymer of the same kind that merely does not have any associative groups. Details of the use of hydrophobically associating copolymers for tertiary mineral oil production are described, for example, in the review article by Taylor, K. C. and Nasr-El-Din, H. A. in J. Petr. Sci. Eng. 1998, 19, 265-280.

It is also known in the art to enhance the thickening effect of polyacrylamides by using additionally associative monomers thereby obtaining hydrophobically associating polyacrylamides. Such associative monomers are water-soluble, monoethylenically unsaturated monomers having at least one hydrophilic group and at least one, preferably terminal, hydrophobic group. Examples of polyacrylamides comprising associative monomers have been described for example in EP 705 854 B1, DE 100 37 629 A1, DE 10 2004 032 304 A1, WO 2010/133527 A2, WO 2012/069477 A1, WO 2012/069478 A1, WO 2012/069438 A1, WO 2014/095621 A1, WO 2014/095621 A1, WO 2015/086468 A1 or WO 2017/121669 A1.

A common polymerization technology for manufacturing high molecular weight polyacrylamides, including hydrophobically associating polyacrylamides is the so called “gel polymerization”. In gel polymerization, an aqueous monomer solution having a relatively high concentration of monomers, for example from 20% by weight to 45% by weight is polymerized by means of suitable polymerization initiators under essentially adiabatic conditions in an unstirred reactor thereby forming an aqueous polymer gel. The aqueous polyacrylamide gels formed may be converted to powders by drying the gel. For use, the polyacrylamides typically are again dissolved in water or aqueous fluids. Alternatively, the aqueous polyacrylamide gel may be dissolved in water or aqueous fluids thereby obtaining directly aqueous polyacrylamide solutions.

WO 2015/158517 A1 discloses a method of manufacturing water-soluble polyacrylamides by adiabatic gel polymerization comprising at least the steps of providing an aqueous monomer solution comprising at least water, 25 to 45% by weight of acrylamide and optionally further monoethylenically unsaturated comonomers, a stabilizer and an azo initiator, adding at least one redox initiator (D) for the free-radical polymerization to the monomer solution which has been cooled to less than 5° C., polymerizing the aqueous monomer solution under essentially adiabatic conditions, the initiation temperature of the polymerization being less than 5° C. and the mixture being heated under the influence of the heat of polymerization which develops to a temperature of 60° C. to 100° C., forming a polymer gel, and drying the polymer gel obtained. Associative monomers may be used as comonomers for the disclosed method.

Polymer flooding is an industrial scale process. The polymers used are used only as dilute solutions, but the volumes injected per day are high and the injection is typically continued over months up to several years. The polymer requirement for an average oilfield may quite possibly be 5000 to 10000 t of polymer per year. For an economically viable process, maximum viscosity efficiency, i.e. viscosity per mass, is of great significance. Even a small improvement in the viscosity efficiency can lead to a significant improvement in economic viability.

It was therefore an object of the invention to provide improved thickening polymers for use in polymer flooding.

Accordingly, a process has been found for producing hydrophobically associating polyacrylamides by radically polymerizing an aqueous solution of water-soluble, ethylenically unsaturated monomers comprising at least
water,
40 mole % to 99.995 mole % of at least one monomer (A) selected from the group of (meth)acrylamide, N-methyl(meth)acrylamide, N,N′-dimethyl(meth)acrylamide or N-methylol(meth)acrylamide, wherein the amount relates to the total of all ethylenically unsaturated monomers in the aqueous solution, and
0.005 mole % to 1 mole % of at least one monoethylenically unsaturated monomer (B) selected from the group of

H₂C═C(R¹)—O—(—CH₂—CH(R²)—O—)ₖ—R³ (I),

H₂C═C(R¹)—(C═O)—O—(—CH₂—CH(R²)—O—)ₖ—R³ (II),

H₂C═C(R¹)—R⁴—O—(—CH₂—CH(R⁵)—O—)ₓ—(—CH₂—CH(R⁶)—O—)_{y}—(—CH₂—CH₂O—)_{z}—R⁷ (III),
wherein the amount relates to the total of all ethylenically unsaturated monomers in the aqueous solution, and
wherein the radicals and indices are defined as follows:
   R¹: H or methyl;
   R²: independently H, methyl or ethyl, with the proviso that at least 70 mol % of the R² radicals are H,
   R³: aliphatic and/or aromatic, linear or branched hydrocarbyl radicals having 8 to 40 carbon atoms,
   R⁴: a single bond or a divalent linking group selected from the group consisting of —(CₙH₂ₙ)—, —O—(C_{n′}H_{2n′})— and —C(O)—O—(C_{n″}H_{2n″})—, where n is a natural number from 1 to 6, and n′ and n″ are a natural number from 2 to 6,
   R⁵: independently H, methyl or ethyl, with the proviso that at least 70 mol % of the R⁵ radicals are H,
   R⁶: independently hydrocarbyl radicals of at least 2 carbon atoms,
   R⁷: H or a hydrocarbyl radical having 1 to 30 carbon atoms,
   k a number from 10 to 80,
   x a number from 10 to 50,
   y a number from 5 to 30, and
   z a number from 0 to 10,
under adiabatic conditions in the presence of suitable initiators for radical polymerization thereby obtaining an aqueous polyacrylamide gel, wherein
   the concentration of the monomers is from 1 mole/kg to 3.3 mole/kg, relating to the total of all components of the aqueous monomer solution,
   the aqueous monomer solution has a temperature T₁ not exceeding 30° C. before the onset of polymerization, and
   the temperature of the aqueous polyacrylamide gel T₂ after polymerization is from 45° C. to 80° C.

In another embodiment, the invention also relates to hydrophobically associating polyacrylamides available by the process according to the present invention.

In another embodiment, the invention relates to the use of such hydrophobically associating copolymers for oilfield applications, in particular enhanced oil recovery.

With regard to the invention, the following should be stated specifically: In the process according to the present invention, an aqueous solution of water-soluble, ethylenically unsaturated monomers is polymerized in the presence of suitable initiators for radical polymerization under adiabatic conditions thereby obtaining an aqueous polyacrylamide gel.

### Aqueous Monomer Solution

For polymerization, an aqueous solution comprising at least water and water-soluble, ethylenically unsaturated monomers is provided. Besides the monomers, further additives and auxiliaries may be added to the aqueous monomer solution. As will be detailed below, before polymerization also suitable initiators for radical polymerization are added.

Besides water, the aqueous monomer solution may also comprise additionally water-miscible organic solvents. However, as a rule the amount of water should be at least 70% by wt. relating to the total of all solvents used, preferably at least 85% by wt. and more preferably at least 95% by wt. In one embodiment, only water is used as solvent.

The term “water-soluble monomers” in the context of this invention means that the monomers are to be soluble in the aqueous monomer solution to be used for polymerization in the desired use concentration. It is thus not absolutely necessary that the monomers to be used are miscible with water without any gap; instead, it is sufficient if they meet the minimum requirement mentioned. It is to be noted that the presence of monomers (A) in the monomer solution might enhance the solubility of other monomers as compared to water only. In general, the solubility of the water-soluble monomers in water at room temperature should be at least 50 g/l, preferably at least 100 g/l.

According to the invention, the aqueous solution comprises at least the monoethylenically unsaturated monomers (A) and (B). In other embodiments of the invention further water-soluble, monoethylenically unsaturated monomers (C) different from monomers (A) and (B) may be present.

### Monomers (A)

Monomers (A) selected from the group of (meth)acrylamide, N-methyl(meth)acrylamide, N,N′-dimethyl(meth)acrylamide or N-methylol(meth)acrylamide. Monomer (A) preferably is (meth)acrylamide, especially acrylamide. If mixtures of different monomers (A) are used, at least 50 mol % of the monomers (A) should be (meth)acrylamide, preferably acrylamide. In one embodiment of the invention, the monomer (A) is acrylamide.

According to the invention, the amount of the monomers (A) is from 40 mole % to 99.995 mole %, preferably from 45 mole % to 99.995 mole %, wherein the amount relates to the total of all ethylenically unsaturated monomers in the aqueous solution.

### Monomers (B)

Besides monomers (A) the aqueous solution comprises at least one monomer (B). The monomers (B) are selected from monomers having the general formula

H₂C═C(R¹)—O—(—CH₂—CH(R²)—O—)ₖ—R³ (I),

H₂C═C(R¹)—(C═O)—O—(—CH₂—CH(R²)—O—)ₖ—R³ (II), or

H₂C═C(R¹)—R⁴—O—(—CH₂—CH(R⁵)—O—)ₓ—(—CH₂—CH(R⁶)—O—)_{y}—(—CH₂—CH₂O—)_{z}—R⁷ (III).

In the formulae (I), (II) and (III), R¹ is H or methyl, preferably H.

The R² moieties are each independently H, methyl or ethyl, preferably H or methyl, with the proviso that at least 70 mol % of the R² radicals are H. Preferably at least 80 mol % of the R² radicals are H, more preferably at least 90 mol %, and they are most preferably exclusively H. This block is thus a polyoxyethylene block which may optionally include certain proportions of propylene oxide and/or butylene oxide units, preferably a pure polyoxyethylene block.

The number of alkylene oxide units k is a number from 10 to 80, preferably 12 to 60, more preferably 15 to 50 and, for example, 20 to 40. It will be apparent to the person skilled in the art in the field of alkylene oxides that the values mentioned are mean values.

R³ is an aliphatic and/or aromatic, straight-chain or branched hydrocarbyl radical having 8 to 40 carbon atoms, preferably 12 to 32 carbon atoms. In one embodiment, the aliphatic hydrocarbyl groups are those having 8 to 22 and preferably 12 to 18 carbon atoms. Examples of such groups include n-octyl, n-decyl, n-dodecyl, n-tetradecyl, n-hexadecyl or n-octadecyl groups. In a further embodiment, the groups are aromatic groups, especially substituted phenyl radicals, especially distyrylphenyl groups and/or tristyrylphenyl groups.

In the monomers (B) of the formula (III), an ethylenic H₂C═C(R²)— group is bonded via a divalent linking —R⁴—O— group to a polyoxyalkylene radical having block structure, where the —(—CH₂—CH(R⁵)—O—)ₓ—, —(—CH₂—CH(R⁶)—O—)ₗ- and optionally —(—CH₂—CH₂O—)_{z}—R⁷ blocks are arranged in the sequence shown in formula (III). The transition between the two blocks may be abrupt or else continuous.

In formula (III), R¹ has the definition already defined, i.e. R¹ is H or a methyl group, preferably H.

R⁴ is a single bond or a divalent linking group selected from the group consisting of —(CₙH₂ₙ)—, —O—(C_{n′}H_{2n′})— and —C(O)—O—(C_{n″}H_{2n′})—. In the formulae mentioned, n in each case is a natural number from 1 to 6; n′ and n″ are each a natural number from 2 to 6. In other words, the linking group comprises straight-chain or branched aliphatic hydrocarbyl groups which have 1 to 6 carbon atoms and may be joined directly, via an ether group —O— or via an ester group —C(O)—O— to the ethylenic H₂C═C(R²)— group. The —(CₙH₂ₙ)—, —(C_{n′}H_{2n′})— and —(C_{n″}H_{2n″})— groups are preferably linear aliphatic hydrocarbyl groups.

Preferably, the —(CₙH₂ₙ)— group is a group selected from —CH₂—, —CH₂—CH₂— and —CH₂—CH₂—CH₂—, more preferably a methylene group —CH₂—.

Preferably, the —O—(C_{n′}H_{2n′})— group is a group selected from —O—CH₂—CH₂—, —O—CH₂—CH₂—CH₂— and —O—CH₂—CH₂—CH₂—CH₂—, more preferably —O—CH₂—CH₂—CH₂—CH₂—.

Preferably, the —C(O)—O—(C_{n″}H_{2n″})— group is a group selected from —C(O)—O—CH₂—CH₂—, —C(O)O—CH(CH₃)—CH₂—, —C(O)O—CH₂—CH(CH₃)—, —C(O)O—CH₂—CH₂—CH₂—CH₂— and —C(O)O—CH₂—CH₂—CH₂—CH₂—CH₂—CH₂—, more preferably —C(O)—O—CH₂—CH₂— and —C(O)O—CH₂—CH₂—CH₂—CH₂—, and most preferably is —C(O)—O—CH₂—CH₂—.

More preferably, the R⁴ group is a —O—(C_{n′}H_{2n′})— group, most preferably a group —O—CH₂—CH₂—CH₂—CH₂—.

In the —(—CH₂—CH(R⁵)—O—)ₓ— block, the R⁵ radicals are independently H, methyl or ethyl, preferably H or methyl, with the proviso that at least 70 mol % of the R⁵ radicals are H. Preferably at least 80 mol % of the R⁵ radicals are H, more preferably at least 90 mol %, and they are most preferably exclusively H. This block is thus a polyoxyethylene block which may optionally include certain proportions of propylene oxide and/or butylene oxide units, preferably a pure polyoxyethylene block.

The number of alkylene oxide units x is a number from 10 to 50, preferably 12 to 40, more preferably 15 to 35, even more preferably 20 to 30 and, for example, 23 to 26. It will be apparent to the person skilled in the art in the field of polyalkylene oxides that the numbers mentioned are mean values of distributions.

In the second —(CH₂—CH(R⁶)—O)_{y}— block, the R⁶ radicals are independently hydrocarbyl radicals of at least 2 carbon atoms, for example 2 to 10 carbon atoms, preferably 2 or 3 carbon atoms. This may be an aliphatic and/or aromatic, linear or branched carbon radical. Preference is given to aliphatic radicals.

Examples of suitable R⁶ radicals include ethyl, n-propyl, n-butyl, n-pentyl, n-hexyl, n-heptyl, n-octyl, n-nonyl or n-decyl and phenyl. Examples of preferred radicals include ethyl, n-propyl, n-butyl, n-pentyl, especially ethyl and/or n-propyl radicals, and more preferably ethyl radicals. The —(—CH₂—CH(R⁶)—O—)_{y}— block is thus a block consisting of alkylene oxide units having at least 4 carbon atoms.

The number of alkylene oxide units y is a number from 5 to 30, preferably 8 to 25.

In formula (III), z is a number from 0 to 10, preferably 0 to 5, i.e. the terminal block of ethylene oxide units is thus only optionally present. In one embodiment of the invention, z is a number >0 to 10, especially >0 to 10 and, for example, 1 to 4.

The R⁷ radical is H or a preferably aliphatic hydrocarbyl radical having 1 to 30 carbon atoms, preferably 1 to 10 and more preferably 1 to 5 carbon atoms. R⁷ is preferably H, methyl or ethyl, more preferably H or methyl and most preferably H.

In a preferred embodiment of the invention, at least one of the monomers (B) is a monomer of the formula (III).

In a further preferred embodiment of the invention, a mixture of at least two different monomers (B) of the formula (III) is used, where the radicals R¹, R⁴, R⁵, R⁶, and R⁷ and the indices x and y are the same in each case. In addition, z=0 in one of the monomers, while z is a number >0 to 10, preferably 1 to 4, in the other. Said preferred embodiment is thus a mixture of the following composition:

H₂C═C(R¹)—R⁴—O—(—CH₂—CH(R⁵)—O—)ₓ—(—CH₂—CH(R⁶)—O—)_{y}-H (IIIa) and

H₂C═C(R¹)—R⁴—O—(—CH₂—CH(R⁵)—O—)ₓ—(—CH₂—CH(R⁶)—O—)_{y}—(—CH₂—CH₂O—)_{z}—H (IIIb),

where the radicals and indices have the definition outlined above, including the preferred embodiments thereof, with the proviso that, in the formula (IIIb), z is a number >0 to 10.

Preferably, in the formulae (IIIa) and (IIIb), R¹ is H, R⁴ is —O—CH₂CH₂CH₂CH₂—, R⁵ is H, R⁶ is ethyl, x is 20 to 30, preferably 23 to 26, y is 12 to 25, preferably 14 to 18, and z is 3 to 5.

The monomers (B) of the formulae (I), (II) and (III), the preparation thereof and acrylamide copolymers comprising these monomers and the preparation thereof are known in principle to those skilled in the art, for example from WO 85/03510 A1, WO 2010/133527 A1, WO 2012/069478 A1, WO 2014/095608 A1, WO 2014/095621 A1 and WO 2015/086486 A1 and in the literature cited therein.

According to the invention, the amount of the monomers (b) is 0.005 mole % to 1 mole % by weight based on the sum total of all the monomers, preferably 0.005 mole % to 0.2 mole %, and more preferably 0.005 mole % to 0.1 mole %.

### Monomers (C)

In other embodiments of the invention in the monomer aqueous solution further water-soluble, monoethylenically unsaturated monomers (C) different from monomers (A) and (B) may be present. Preferably, the hydrophobically associating polyacrylamides according to the present invention comprise at least the monomers (A), (B), and (C).

Basically, the kind of water-soluble monomers (C) is not limited and depends on the desired properties and the desired use of the hydrophobically associating polyacrylamides to be manufactured. The amount of monomers (C) may be up to 59.995 mole % relating to the total of all monomers, for example from 1 mol % to 59.995 mole % or from 10 mole % to 59.98 mole %.

### Neutral Monomers (C)

Examples of monomers (C) include neutral monomers comprising hydroxyl and/or ether groups, for example hydroxyethyl(meth)acrylate, hydroxypropyl(meth)acrylate, allyl alcohol, hydroxyvinylethylether, hydroxyvinylpropylether, hydroxyvinylbutylether, polyethylene glycol (meth)acrylate, N-vinylformamide, N-vinylacetamide, N-vinyl-pyrrolidone or N-vinylcaprolactam, and vinyl esters, for example vinylformate or vinyl acetate.

### Anionic Monomers (C)

In a further embodiment of the invention, comonomers may be selected from water-soluble, monoethylenically unsaturated monomers comprising at least one acidic group, or salts thereof. The acidic groups are preferably selected from the group of —COOH, —SO₃H and —PO₃H₂ or salts thereof. Preference is given to monomers comprising COOH groups and/or —SO₃H groups or salts thereof. Suitable counterions include especially alkali metal ions such as Li⁺, Na⁺ or K⁺, and also ammonium ions such as NH₄⁺ or ammonium ions having organic radicals. Examples of ammonium ions having organic radicals include [NH(CH₃)₃]⁺, [NH₂(CH₃)₂]⁺, [NH₃(CH₃)]⁺, [NH(C₂H₅)₃]⁺, [NH₂(C₂H₅)₂]⁺, [NH₃(C₂H₅)]⁺, [NH₃(CH₂CH₂OH)]⁺, [H₃N—CH₂CH₂—NH₃]²⁺ or [H(H₃C)₂N—CH₂CH₂CH₂NH₃]²⁺.

Examples of monomers comprising —COOH groups include acrylic acid, methacrylic acid, crotonic acid, itaconic acid, maleic acid or fumaric acid or salts thereof. Preference is given to acrylic acid or salts thereof.

Examples of monomers comprising-SO₃H groups or salts thereof include vinylsulfonic acid, allylsulfonic acid, 2-acrylamido-2-methylpropanesulfonic acid (ATBS), 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid. Preference is given to 2-acrylamido-2-methylpropanesulfonic acid (ATBS) or salts thereof.

Examples of monomers comprising —PO₃H₂ groups or salts thereof include vinylphosphonic acid, allylphosphonic acid, N-(meth)acrylamidoalkylphosphonic acids or (meth)acryloyloxyalkylphosphonic acids, preferably vinylphosphonic acid.

Preferred monomers comprising acidic groups comprise acrylic acid and/or ATBS or salts thereof.

### Cationic Monomers (C)

In a further embodiment of the invention, comonomers may be selected from water-soluble, monoethylenically unsaturated monomers comprising cationic groups. Suitable cationic monomers include especially monomers having ammonium groups, especially ammonium derivatives of N-(ω-aminoalkyl)(meth)acrylamides or ω-aminoalkyl(meth)acrylates such as 2-trimethylammonioethyl acrylate chloride H₂C═CH—CO—CH₂CH₂N⁺(CH₃)₃Cl⁻ (DMA3Q). Further examples have been mentioned in WO 2015/158517 A1 page 8, lines 15 to 37. Preference is given to DMA3Q.

### Further Comonomers (D)

Besides the monomers (A), (B), and optionally (C), the aqueous monomer solution may comprise further ethylenically unsaturated monomers different from (A), (B), and (C). Examples comprise water-soluble, ethylenically unsaturated monomers having more than one ethylenic group. Monomers of this kind can be used in special cases in order to achieve easy crosslinking of the acrylamide polymers. The amount of such monomers comprising more than one ethylenically unsaturated group should generally not exceed 1 mole %, preferably 0.5 mole %, based on the sum total of all the monomers. More preferably, the monomers to be used in the present invention are only monoethylenically unsaturated monomers, in particular only monoethylenically unsaturated monomers (A), (B), and (C) are used.

### Concentration of the Monomers

According to the present invention, the concentration of the monomers is from 1 mole/kg to 3.3 mole/kg, relating to the total of all components of the aqueous monomer solution. Preferably, the concentration is from 1.5 mole/kg to 3.3 mole/kg.

As will be detailed below, the choice of said concentration range yields hydrophobically associating polyacrylamides with improved viscosity efficiency.

### Further Components

Besides the monomers, further additives and auxiliaries may be added to the aqueous monomer solution. As will be detailed below, before polymerization also suitable initiators for radical polymerization are added. Examples of such further additives and auxiliaries comprise complexing agents, defoamers, surfactants, stabilizers, and bases or acids for adjusting the pH value. In certain embodiments of the invention, the pH-value of the aqueous monomer solution is adjusted to values from pH 5 to pH 7, for example pH 6 to pH 7.

In one embodiment, the aqueous monomer solution comprises at least one stabilizer for the prevention of polymer degradation. Such stabilizers for the prevention of polymer degradation are what are called “free-radical scavengers”, i.e. compounds which can react with free radicals (for example free radicals formed by heat, light, redox processes), such that said radicals can no longer attack and hence degrade the polymer. Using such kind of stabilizers for the stabilization of aqueous solutions of polyacrylamides basically is known in the art, as disclosed for example in WO 2015/158517 A1, WO 2016/131940 A1, or WO 2016/131941 A1.

The stabilizers may be selected from the group of non-polymerizable stabilizers and polymerizable stabilizers. Polymerizable stabilizers comprise a monoethylenically unsaturated group and become incorporated into the polymer chain in course of polymerization. Non-polymerizable stabilizers don't comprise such monoethylenically unsaturated groups and are not incorporated into the polymer chain.

In one embodiment of the invention, stabilizers are non-polymerizable stabilizers selected from the group of sulfur compounds, sterically hindered amines, N-oxides, nitroso compounds, aromatic hydroxyl compounds or ketones.

Examples of sulfur compounds include thiourea, substituted thioureas such as N,N′-dimethylthiourea, N,N′-diethylthiourea, N,N′-diphenylthiourea, thiocyanates, for example ammonium thiocyanate or potassium thiocyanate, tetramethylthiuram disulfide, and mercaptans such as 2-mercaptobenzothiazole or 2-mercaptobenzimidazole or salts thereof, for example the sodium salts, sodium dimethyldithiocarbamate, 2,2′-dithiobis(benzothiazole), 4,4′-thiobis(6-t-butyl-m-cresol).

Further examples include dicyandiamide, guanidine, cyanamide, paramethoxyphenol, 2,6-di-t-butyl-4-methylphenol, butylhydroxyanisole, 8-hydroxyquinoline, 2,5-di(t-amyl)-hydroquinone, 5-hydroxy-1,4-naphthoquinone, 2,5-di(t-amyl)hydroquinone, dimedone, propyl 3,4,5-trihydroxybenzoate, ammonium N-nitrosophenylhydroxylamine, 4-hydroxy-2,2,6,6-tetramethyoxylpiperidine, (N-(1,3-dimethylbutyl)-N′-phenyl-p-phenylenediamine and 1,2,2,6,6-pentamethyl-4-piperidinol.

Preference is given to sterically hindered amines such as 1,2,2,6,6-pentamethyl-4-piperidinol and sulfur compounds, preferably mercapto compounds, especially 2-mercaptobenzothiazole or 2-mercaptobenzimidazole or the respective salts thereof, for example the sodium salts, and particular preference is given to 2-mercaptobenzothiazole or salts thereof, for example the sodium salts.

The amount of such non-polymerizable stabilizers—if present—may be from 0.1% to 2.0% by weight, relating to the total of all monomers in the aqueous monomer solution, preferably from 0.15% to 1.0% by weight and more preferably from 0.2% to 0.75% by weight.

In another embodiment of the invention, the stabilizers are polymerizable stabilizers substituted by a monoethylenically unsaturated group. With other words, such stabilizers are also monomers (C). Examples of stabilizers comprising monoethylenically unsaturated groups comprise (meth)acrylic acid esters of 1,2,2,6,-pentamethyl-4-piperidinol or other monoethylenically unsaturated groups comprising 1,2,2,6,6-pentamethyl-piperidin-4-yl groups. Specific examples of suitable polymerizable stabilizers are disclosed in WO 2015/024865 A, page 22, lines 9 to 19. In one embodiment of the invention, the stabilizer is a (meth)acrylic acid ester of 1,2,2,6,6-pentamethyl-4-piperidinol.

The amount of polymerizable stabilizers—if present—may be from 0.01 to 2% by weight, based on the sum total of all the monomers in the aqueous monomer solution, preferably from 0.02% to 1% by weight, more preferably from 0.05% to 0.5% by weight.

In one embodiment, the aqueous monomer solution comprises at least one non-polymerizable surfactant. Examples of suitable surfactants including preferred amounts have been disclosed in WO 2015/158517 A1, page 19, line, 23 to page 20, line 27. In the manufacture of hydrophobically associating polyacrylamides, the surfactants lead to a distinct improvement of the product properties. If present, such non-polymerizable surfactant may be used in an amount of 0.1 to 5% by weight, for example 0.5 to 3% by weight based on the amount of all the monomers used.

### Preferred Compositions

In one embodiment, the aqueous solutions comprises 40 mole % to 99.995 mole % of acrylamide and 0.005 mole % to 0.2 mole % of monomers (B), preferably those of formula (III), wherein the amounts relate to the total amount of all monomers in the aqueous monomer solution.

In another embodiment, the aqueous solution comprises 40 mole % to 98.995 mole % of acrylamide and 0.005 mole % to 0.2 mole % of monomers (B), preferably those of formula (III) and 1 mole % to 59.995 mole % of at least one monomer (C), preferably an anionic monomer (C), more preferably acrylic acid and/or ATBS or salts thereof.

In another embodiment, the aqueous solution comprises 65 mole % to 79.995 mole % of acrylamide and 0.005 mole % to 0.2 mole % of monomers (B), preferably those of formula (III) and 20 mole % to 34.995 mole % of at least one monomer (C), preferably an anionic monomer (C), more preferably acrylic acid and/or ATBS or salts thereof.

In all embodiments, the amounts relate to the total amount of all monomers in the aqueous monomer solution.

### Polymerization

According to the present invention, the aqueous monomer solution is polymerized in the presence of suitable initiators for radical polymerization under adiabatic conditions thereby obtaining an aqueous polyacrylamide gel.

Such a polymerization technique is also briefly denominated by the skilled artisan as “adiabatic gel polymerization”. Reactors for adiabatic gel polymerization are unstirred. Due to the relatively high monomer concentration the aqueous monomer solution used solidifies in course of polymerization thereby yielding an aqueous polymer gel. The term “polymer gel” has been defined for instance by L. Z. Rogovina et al., Polymer Science, Ser. C, 2008, Vol. 50, No. 1, pp. 85-92. According to Rogovina et al., gels may be chemically crosslinked or the gels may be physical gels. While crosslinked gels naturally are insoluble (but swellable) in solvents physical gels are soluble.

“Adiabatic” is understood by the person skilled in the art to mean that there is no exchange of heat with the environment. This ideal is naturally difficult to achieve in practical chemical engineering. In the context of this invention, “adiabatic” shall consequently be understood to mean “essentially adiabatic”, meaning that the reactor is not supplied with any heat from the outside during the polymerization, i.e. is not heated, and the reactor is not cooled during the polymerization. However, it will be clear to the person skilled in the art that—according to the internal temperature of the reactor and the ambient temperature—certain amounts of heat can be released or absorbed via the reactor wall because of temperature gradients. Naturally, this effect plays an ever lesser role with increasing reactor size.

The polymerization of the aqueous monomer solution generates polymerization heat. Due to the adiabatic reaction conditions the temperature of the polymerization mixture increases in course of polymerization.

Suitable reactors for performing adiabatic gel polymerizations are known in the art. Particularly advantageously, the polymerization can be conducted using conical reactors, as described, for example, by U.S. Pat. Nos. 5,633,329 or 7,619,046 B2. In one embodiment of the invention, the reactor comprises a cylindrical upper part and a conical part at its lower end. At the lower end, there is a bottom opening which may be opened and closed. After polymerization, the aqueous polyacrylamide gel formed is removed through the opening.

The polymerization is performed in the presence of suitable initiators for radical polymerization. Suitable initiators for radical polymerization, in particular for adiabatic gel polymerization are known to the skilled artisan.

In a preferred embodiment, redox initiators are used for initiating. Redox initiators can initiate a free-radical polymerization even at temperatures of less than +5° C. Examples of redox initiators are known to the skilled artisan and include systems based on Fe²⁺/Fe³⁺—H₂O₂, Fe²⁺/Fe³⁺-alkyl hydroperoxides, alkyl hydroperoxides—sulfite, for example t-butyl hydroperoxide—sodium sulfite, peroxides—thiosulfate or alkyl hydroperoxides—sulfinates, for example alkyl hydroperoxides/hydroxymethane-sulfinates, for example t-butyl hydroperoxide—sodium hydroxymethanesulfinate.

Furthermore, water-soluble azo initiators may be used. The azo initiators are preferably fully water-soluble, but it is sufficient that they are soluble in the monomer solution in the desired amount. Preferably, azo initiators having a 10 h t_{1/2} in water of 40° C. to 70° C. may be used. The 10-hour half-life temperature of azo initiators is a parameter known in the art. It describes the temperature at which, after 10 h in each case, half of the amount of initiator originally present has decomposed.

Examples of suitable azo initiators having a 10 h t_{1/2} temperature between 40 and 70° C. include 2,2′-azobis[2-(2-imidazolin-2-yl)propane] dihydrochloride (10 h t_{1/2} (water): 44° C.), 2,2′-azobis(2-methylpropionamidine) dihydrochloride (10 h t_{1/2} (water): 56° C.), 2,2′-azobis[N-(2-carboxyethyl)-2-methylpropionamidine hydrate (10 h t_{1/2} (water): 57° C.), 2,2′-azobis{2-[1-(2-hydroxyethyl)-2-imidazolin-2-yl]propane} dihydrochloride (10 h t_{1/2} (water): 60° C.), 2,2′-azobis(1-imino-1-pyrrolidino-2-ethylpropane) dihydrochloride (10 h t_{1/2} (water): 67° C.) or azobis(isobutyronitrile) (10 h t_{1/2} (toluene): 67° C.).

In one embodiment of the invention a combination of at least one redox initiator and at least one azo initiator is used. The redox initiator efficiently starts polymerization already at temperatures below +5° C. When the reaction mixture heats up, also the azo initiators decompose and also start polymerization.

In the following, the temperature of the aqueous monomer solution before the onset of polymerization shall be denominated as T₁ and the temperature of the aqueous polymer gel directly after polymerization shall be denominated as T₂. It goes without saying that T₂>T₁.

Within the context of the present invention, the temperature T₁ should not exceed 30° C. In particular, T₁ should not exceed 25° C. In certain embodiments, T₁ should not exceed 20° C., and in one embodiment T₁ should not exceed 5° C. In one embodiment, T₁ is in the range from −5° C. to +20° C., more preferably from −5° C. to +5° C.

As the polymerization is carried out under adiabatic conditions, the temperature T₂ reached in course of polymerization is not influenced by external heating or cooling but only depends on the polymerization parameters chosen. But suitable choice of the polymerization parameters, the skilled artisan can adjust T₂. Because the reaction is adiabatic, the temperature increase in course of polymerization basically depends on the heat of polymerization generated in course of polymerization, the heat capacity of contents of the polymerization unit and the temperature T₁ of the monomer solution, i.e. the temperature before the onset of polymerization. Due to high water contents of the mixture for polymerization the heat capacity of the mixture for polymerization is dominated by the heat capacity of water and it may of course be measured. The polymerization heat per mole for common monoethylenically unsaturated monomers is known in the art and may therefore be gathered from the scientific literature. Of course, it may also be measured. So, it is possible for the skilled artisan to calculate at least roughly the heat of polymerization for specific monomer compositions and specific monomer concentrations. The higher the concentration of the monoethylenically unsaturated monomers in the aqueous solution the more heat of polymerization is generated. T₂ may be roughly calculated from the parameter mentioned above by the formula T₂=T₁+[(polymerization heat)/(heat capacity)].

According to the invention, the staring temperature T₁ and the concentration of the monomers in the aqueous monomer solution is selected such, that the temperature T₂ from 45° C. to 80° C., preferably from 50° C. to 70° C., for example from 55° C. to 70° C.

In one embodiment, T₁ is from −5° C. to +20° C. and T₂ is from 45° C. to 80° C., preferably from 50° C. to 80° C., more preferably from 50° C. to 70° C. and for example from 55° C. to 70° C. In another embodiment, T₁ is from −5° C. to +5° C. and T₂ is from 45° C. to 80° C., preferably from 50° C. to 80° C., more preferably from 50° C. to 70° C. and for example from 55° C. to 70° C.

As will be detailed in the examples and comparative examples, limiting T₂ to not more than 80° C. by a suitable choice of the concentration of the monomers and T₁ yields hydrophobically associating polyacrylamides having improved viscosity at the same polymer concentration. With other words, the amount of polymer needed to achieve a certain viscosity is lower thereby achieving a more economic process.

Before polymerization oxygen from the reactor and the aqueous monomer solution to be polymerized is removed in basically known manner. Deoxygenation is also known as inertization. By the way of example, inert gases such as nitrogen or argon may be injected into the reactor filled with the aqueous monomer solution.

The polymerization yields an aqueous polyacrylamide gel hold in the polymerization reactor. For further processing, the aqueous polyacrylamide gel is removed from the polymerization reactor. Preferably, the aqueous polyacrylamide gel may be removed by applying pressure onto the gel and pressing it through an opening in the polymerization reactor. By the way of example, pressure may be generated by mechanical means such as a piston, by means of gases such as compressed air, nitrogen, argon or by means of aqueous fluids, in particular water.

The aqueous polyacrylamide gel obtained may by be further processed by drying. Downstream processing may include further steps such as sieving and grinding thereby yielding a polyacrylamide powder. Such polyacrylamide powders may be transported to the location of use, e.g. to an oilfield or a mining area. At such locations, the polyacrylamide powders may be dissolved in water or aqueous fluids for use.

In another embodiment, the aqueous polyacrylamide gel obtained may also be further processed by directly dissolving the aqueous polyacrylamide gel in aqueous fluids, in particular water, thereby obtaining an aqueous polyacrylamide solution. Such a procedure saves costs for drying and re-dissolving polyacrylamides. In one embodiment, the aqueous polyacrylamide gel may be transported to the location of use and dissolved at the location of use. In another embodiment, the process according to the present invention may be performed on-site, i.e. at the location of use such as on an oilfield or in a mining area.

### Hydrophobically Associating Polyacrylamides

The invention also relates to hydrophobically associating polyacrylamides available by the process according to the present invention.

Details of the process including preferred parameters and indices have already been mentioned above and we refer to said disclosure.

Such hydrophobically associating polyacrylamides comprise at least monomers (A) and (B) and optionally (C) and (D) in the amounts as outlined above. However, they differ from hydrophobically associating polyacrylamides having the same composition but polymerized at monomer concentrations of more than 3.3 mole/kg by yielding a higher viscosity in aqueous solution at the same polymer concentration, i.e. having a higher viscosity efficiency.

Preferred compositions of hydrophobically associating copolymers have already been mentioned above.

### Use of the Hydrophobically Associating Polyacrylamides

The hydrophobically associating polyacrylamides according to the present invention may be used for various purposes, for example for mining applications, oilfield applications, water treatment, waste water cleanup, paper making or agricultural applications. Examples of oilfield applications include enhanced oil recovery, oil well drilling or the use as friction reducers, for example friction reducers for fracturing fluids.

In one embodiment of the hydrophobically associating polyacrylamides according to the present invention are used for enhanced oil recovery.

Accordingly, the present invention also relates a method for producing mineral oil from underground mineral oil deposits by injecting an aqueous fluid comprising at least the hydrophobically associating polyacrylamides according to the present invention into a mineral oil deposit through at least one injection well and withdrawing crude oil from the deposit through at least one production well.

For the method of enhanced oil recovery, at least one production well and at least one injection well are sunk into the mineral oil deposit. In general, a deposit will be provided with a plurality of injection wells and with a plurality of production wells. An aqueous fluid is injected into the mineral oil deposit through the at least one injection well, and mineral oil is withdrawn from the deposit through at least one production well. By virtue of the pressure generated by the aqueous fluid injected, called the “polymer flood”, the mineral oil flows in the direction of the production well and is produced through the production well. In this context, the term “mineral oil” does not of course just mean a single-phase oil; instead, the term also encompasses the customary crude oil-water emulsions.

For enhanced oil recovery hydrophobically associating polyacrylamides only comprising the monomers (A) and (B) may be used, but preferably polyacrylamides comprising at least monomers (A), (B), and (C) are used. Preferably, monomers (C) comprising acidic groups may be used, in particular acrylic acid and/or ATBS or salts thereof.

The aqueous fluid for injection can be made up in freshwater or else in water comprising salts, such as seawater or formation water. The aqueous injection fluid may of course optionally comprise further components. Examples of further components include biocides, stabilizers, free-radical scavengers, initiators, surfactants, cosolvents, bases and complexing agents.

The concentration of the hydrophobically associating polyacrylamides in the injection fluid should be chosen as such that the aqueous formulation has the desired viscosity for the end use. The viscosity of the formulation should generally be at least 5 mPas (measured at 25° C. and a shear rate of 7 s⁻¹), preferably at least 10 mPas.

In general, the concentration of the polyacrylamides in the injection fluid is 0.02 to 2% by weight based on the sum total of all the components in the aqueous formulation. The amount is preferably 0.05 to 0.5% by weight, more preferably 0.1 to 0.3% by weight and, for example, 0.1 to 0.2% by weight.

In another embodiment of the hydrophobically associating polyacrylamides according to the present invention are used for conformance control.

Accordingly, the present invention also relates to a method of using the hydrophobically associating polyacrylamides according to the present invention for producing mineral oil from underground mineral oil deposits, comprising at least the steps of (i) blocking permeable regions of the underground mineral oil deposit by injecting an aqueous formulation into the formation through at least one well, said aqueous formulation comprising at least said hydrophobically associating polyacrylamides, and (ii) injecting an aqueous flooding medium into at least one injection well and withdrawing mineral oil through the at least one production well.

In process step (i), permeable regions of the underground mineral oil deposit are blocked by injecting an aqueous formulation through at least one well sunk into the formation, said aqueous formulation comprising hydrophobically associating polyacrylamides according to the present invention. The term “blocking” means here that the permeable regions are completely or at least partially blocked, which means that the flow resistance of the permeable regions for aqueous media should increase due to the treatment with the aqueous formulation of the copolymer. This can occur, for example, as a result of the copolymer forming a gel in the permeable regions and blocking them, or it can occur as a result of the copolymer forming a coating on the surface of the formation and the constriction of the flow paths blocking the flow resistance in the permeable regions. In process step (ii), mineral oil is actually produced by injecting an aqueous flooding medium into at least one injection well and withdrawing mineral oil through at least one production well. The injected aqueous flooding medium maintains the pressure and forces the mineral oil from the injection wells in the direction of the production wells.

In another embodiment of the hydrophobically associating polyacrylamides according to the present invention are used as friction reducers in hydraulic fracturing applications.

Hydraulic fracturing involves injecting fracturing fluid through a wellbore and into a formation under sufficiently high pressure to create fractures, thereby providing channels through which formation fluids such as oil, gas or water, can flow into the wellbore and thereafter be withdrawn. Fracturing fluids are designed to enable the initiation or extension of fractures and the simultaneous transport of suspended proppant (for example, naturally-occurring sand grains, resin-coated sand, sintered bauxite, glass beads, ultra-lightweight polymer beads and the like) into the fracture to keep the fracture open when the pressure is released.

In one embodiment of hydraulic fracturing, fracturing fluids having a high viscosity are used. Such a high viscosity may be achieved by crosslinked polymers, such as crosslinked guar. Such a high viscosity is necessary to ensure that the proppants remain distributed in the fracking fluid and do not sediment, for example already in the wellbore.

In another embodiment of hydraulic fracturing, also known as “slickwater fracturing”, fluids having only a low viscosity are used. Such fluids mainly comprise water. In order to achieve proppant transport into the formation, the pumping rates and the pressures used are significantly higher than for high-viscosity fluids. The turbulent flow of the fracking fluid causes significant energy loss due to friction. In order to avoid or at least minimize such friction losses, high molecular weight polyacrylamides may be used which change turbulent flow to laminar flow.

Accordingly, in another embodiment the present invention relates to a method of fracturing subterranean formations by injecting an aqueous fracturing fluid comprising at least water, proppants and a fraction reducer through a wellbore into a subterranean formation at a pressure sufficient to flow into the formation and to initiate or extend fractures in the formation, wherein the fraction reducer comprises an aqueous polyacrylamide solution prepared by the process for producing an aqueous polyacrylamide solution as described above. Details of the process have already been disclosed above. In that embodiment, location B is at a production well well to be treated with aqueous polyacrylamide solutions or close to such a production well.

The invention is illustrated in detail by the examples which follow.

### Performance Tests

### Viscosity of the Polyacrylamides in Aqueous Solution

Measurements were performed in “pH 7 buffer”: For 10 l of pH 7 buffer fully dissolve 583.3±0.1 g sodium chloride, 161.3±0.1 g disodium hydrogenphosphate.12H₂O and 7.80±0.01 g sodium dihydrogenphosphate.2H₂O in 10 l dist. or deionized water. A 5000 ppm polymer solution was obtained by dissolving the appropriate amount of aqueous polyacrylamide gel in pH 7 buffer until being fully dissolved. Viscosity measurements were performed at a Brookfield RS rheometer with single gap geometry.

### Filtration Ratio

### Determination of MPFR (Millipore Filtration Ratio)

The filterability of the polymer solutions was characterized using the MPFR value (Millipore filtration ratio). The MPFR value characterizes the deviation of a polymer solution from ideal filtration characteristics, i.e. when there is no reduction of the filtration rate with increasing filtration. Such a reduction of the filtration rate may result from the blockage of the filter in course of filtration.

To determine the MPFR values, about 200 g of the relevant polyacrylamide solution having a concentration of 1000 ppm were filtered through a polycarbonate filter have a pore size of 5 μm at a pressure of 2 bar and the amount of filtrate was recorded as a function of time.

The MPFR value was calculated by the following formula

MPFR=(t_{180 g}−t_{160 g})/(t_{80 g}−t_{60 g}).

T_{x g} is the time at which the amount solution specified passed the filter, i.e. t_{180 g} is the time at which 180 g of the polyacrylamide solution passed the filter. According to API RP 63 (“Recommended Practices for Evaluation of Polymers Used in Enhanced Oil Recovery Operations”, American Petroleum Institute), values of less than 1.3 are acceptable.

### Gel Fraction

A 5000 ppm polymer solution in pH 7 buffer is diluted to 1000 ppm with pH 7 buffer. The gel fraction is given as mL of gel residue on the sieve when 250 g 1000 ppm polymer solution are filtered over 200 μm sieve and consequently washed with 2 l of tab water.

### Used Associative Monomer:

For the examples, the following macromonomer was used (synthesis according to the procedure disclosed in WO 2017/121669 A1, pages 23-24):

H₂C═CH—O—(CH₂)₄—O—(CH₂CH₂O)_{24.5}—(CH₂CH(C₂H₅)O)₁₆—(CH₂CH₂O)_{3.5}H

### Test Series 1 (Comparative Examples 1 and 2, Examples 1 and 2)

Test of copolymers comprising the same amount of acrylamide, ATBS and macromonomer, however, polymerized at different concentrations.

### Comparative Example 1

### Synthesis of a Copolymer Comprising 47.6 wt. % (75.1 Mole %) of Acrylamide, 50.5 wt. % (24.8 Mole %) of Sodium ATBS and 1.9 wt. % (0.0854 Mol %) of the Macromonomer;

Monomer concentration: 3.49 mole/kg (40% by weight)

A 5 l beaker with magnetic stirrer, pH meter and thermometer was initially charged with 1385.6 g of a 50% aqueous solution of Na-ATBS, and then the following components were added successively: 730 g of distilled water, 1254.5 g of acrylamide (52% by weight in water), 3.5 g of a commercially available silicone defoamer (Xiameter® AFE-0400), 10.5 g of a 5% aqueous solution of the pentasodium salt of diethylenetriamine-pentaacetic acid, 33.9 g of a 85% aqueous solution of the surfactant iC₃O(CH₂CH₂O)₁₂H (Lutensol® TO129), 7 g of a 0.1 wt. % aqueous solution of sodium hypophosphite hydrate.

After adjustment to pH 6.0 with a 10% by weight solution of sulfuric acid, 30 g of an 87% aqueous solution of the macromonomer were added, the pH adjusted back to pH 6.0 and the rest of the water was added to attain the desired monomer concentration of 40% by weight (total amount of water 755.3 g minus the amount of water already added, minus the amount of acid required). 21 g of a 10% aqueous solution of the water-soluble azo initiator 2,2′-azobis(2-methylpropionamidine) dihydrochloride (Wako V-50; 10h t_{1/2} in water 56° C.) was added and the monomer solution was adjusted to the initiation temperature of 0° C. The solution was transferred to a Dewar vessel, the temperature sensor for the temperature recording was inserted, and the flask was purged with nitrogen for 45 minutes. The polymerization was initiated with 1.05 g of a 1% t-BHPO solution and 2.1 g of a 1% sodium sulfite solution. With the onset of the polymerization, the temperature rose to 84° C. within about 25 min. A solid polymer gel was obtained.

After the polymerization, the gel was incubated for 4 hours at Tₘₐₓ and the gel block was comminuted with the aid of a meat grinder. The comminuted aqueous polyacrylamide gel was kept for further testing without drying.

### Comparative Example 2

### Synthesis of a Copolymer Comprising 47.6 wt. % (75.1 Mole %) of Acrylamide, 50.5 wt. % (24.8 Mole %) of Sodium ATBS and 1.9 wt. % (0.0854 Mol %) of the Macromonomer;

Monomer concentration: 3.36 mole/kg (38.5% by weight)

The copolymer was synthesized according to the same procedure as in comparative example 1, except that the concentration of the monomers was reduced from 40% to 38.5%.

### Example 1

### Synthesis of a Copolymer Comprising 47.6 wt. % (75.1 Mole %) of Acrylamide, 50.5 wt. % (24.8 Mole %) of Sodium ATBS and 1.9 wt. % (0.0854 Mol %) of the Macromonomer;

Monomer concentration: 3.1 mole/kg (35.5% by weight) The copolymer was synthesized according to the same procedure as in comparative example 1, except that the concentration of the monomers was reduced from 40% to 35.5%.

### Example 2

### Synthesis of a Copolymer Comprising 47.6 wt. % (75.1 Mole %) of Acrylamide, 50.5 wt. % (24.8 Mole %) of Sodium ATBS and 1.9 wt. % (0.0854 Mole %) of the Macromonomer;

Monomer concentration: 2.83 mole/kg (32.5% by weight)

The copolymer was synthesized according to the same procedure as in comparative example 1, except that the concentration of the monomers was reduced from 40% to 32.5%.

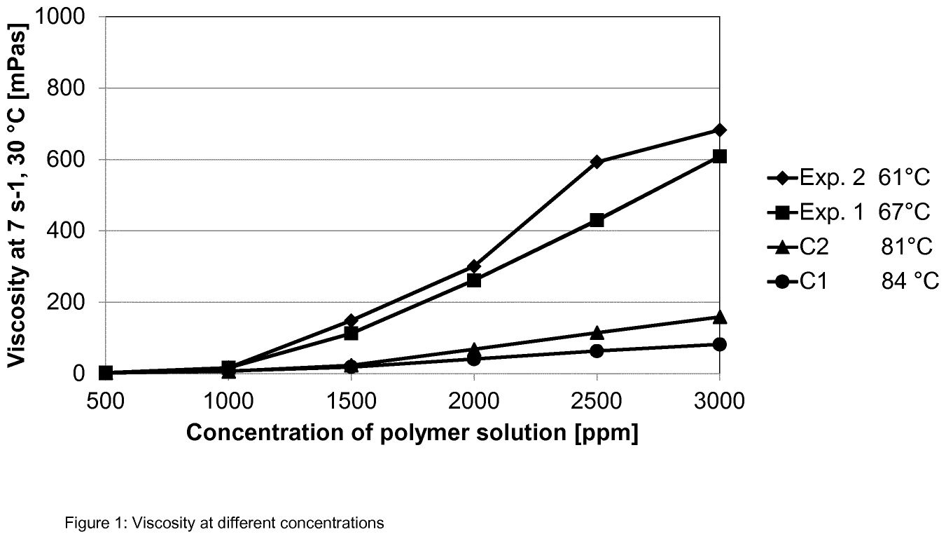

The test results for the polymers C1, C2, 1, and 2 are summarized in table 1. The results of viscosity measurements at 30° C. and 7 s⁻¹ at various polymer concentrations from 500 ppm to 3000 ppm are shown in FIG. 1.

TABLE 1
Test results

| | Concentration | | | | | | |
|---|---|---|---|---|---|---|---|
| | of monomers | | | | Mean | | Mean gel |
| | | DB | T₁ | T₂ | viscosity* | Mean | volume |
| No. | [wt. %] | [mol/kg] | [° C.] | [° C.] | [mPas] | MPFR | [ml] |
| C1 | 40 | 3.49 | 0 | 84 | 105 (4) | 1.16 | 0 |
| C2 | 38.5 | 3.36 | 0 | 81 | 168 (2) | 1.12 | 0 |
| 1 | 35.5 | 3.10 | 0 | 67 | 332 (27) | 1.01 | 0 |
| 2 | 32.5 | 2.83 | 0 | 61 | 489 (5) | 1.06 | 0 |

Viscosity measured at 5000 ppm in pH 7 buffer at RT, 50 s−1.
MPFR measured at 1000 ppm in pH 7 buffer, 2 bar.
DB: double-bond number (moles reactive monomers per kg monomer mixture)
*mean value out of three experiments (in brackets: statistical error)

The examples and comparative examples demonstrate, that with decreasing monomer concentration T₂ decreases (because less polymerization heat generated). Furthermore, also the properties of the polymers are improved. The viscosity of the polymers increases with decreasing concentration/T₂. Besides said effect also the MPFR decreases (the lower the better), i.e. the filterability of the polyacrylamides is increased.

FIG. 1 shows the results of viscosity measurements of aqueous polymer solutions at 30° C. and 7 s⁻¹ at various polymer concentrations from 500 ppm to 3000 ppm. For all polymers tested, the viscosity increases with increasing polymer concentration. However, for polymers C1 and C2 there is only a slight effect while for polymers 1 and 2, there is a very significant viscosity increase.

### Test Series 2 (Comparative Examples 3 and 4, Examples 3 to 5)

Test of copolymers comprising the same amount of acrylamide, ATBS and macromonomer, however, polymerized at different concentrations. Aqueous solution additionally comprises a stabilizer.

Synthesis of a Copolymer Comprising 47.6 wt. % (75.1 Mole %) of Acrylamide, 50.5 wt. % (24.8 Mole %) of Sodium ATBS and 1.9 wt. % (0.0854 Mol %) of the Macromonomer, Stabilized with 0.25% by Wt. Of Sodium-2-Mercaptobenzothiazole (NaMBT)

The polymers and comparative polymers were synthesized in the same manner as comparative example 1, except that 0.25% by weight of the stabilizer NaMBT was added to the monomer phase and the RedOx level was altered to sodium sulfite (9 ppm) and t-BHPO (5 ppm).

The respective monomer concentration chosen as well as the test results are summarized in table 2.

TABLE 2
Test results

| | Concentration | | | | | | |
|---|---|---|---|---|---|---|---|
| | of monomers | | | | Mean | | Mean gel |
| | | DB | T₁ | T₂ | viscosity* | Mean | volume |
| No. | [wt. %] | [mol/kg] | [° C.] | [° C.] | [mPas] | MPFR | [ml] |
| C3 | 40 | 3.48 | 0 | 83.8 | 91(4) | 1.24 | 0 |
| C4 | 38.5 | 3.35 | 0 | 79.1 | 112(5) | 1.18 | 0 |
| 3 | 35.5 | 3.10 | 0 | 70.3 | 221(14) | 1.21 | 0 |
| 4 | 32.5 | 2.83 | 0 | 63.6 | 270(6) | 1.16 | 0 |
| 5 | 29.5 | 2.57 | 0 | 54.9 | 425(16) | 1.22 | 0 |

Viscosity measured at 5000 ppm in pH 7 buffer at RT, 50 s⁻¹.
MPFR measured at 1000 ppm in pH 7 buffer, 2 bar.
DB: double-bond number (moles reactive monomers per kg monomer mixture)
*mean value out of three experiments (in brackets: statistical error)

The results demonstrate that adding a stabilizer to the monomer concentration has an influence on the mean viscosity (as compared to test series 1). However, also in test series 2, the mean viscosity increases with decreasing concentration/T₂.

### Test Series 3 (Comparative Examples 5 and 6, Examples 6 to 8)

Test of copolymers comprising the same amount of acrylamide, Na-acrylate and macromonomer, however, polymerized at different concentrations.

### Comparative Example 5

### Copolymer Comprising 69.5 wt. % (75.4 Mole %) of Acrylamide, 30.0 wt. % (24.6 Mole %) of Sodium-Acrylate and 0.5 wt. % (0.0154 Mole %) Macromonomer

A 5 l beaker with magnetic stirrer, pH meter and thermometer was initially charged with 895.5 g of a 35% aqueous solution of sodium acrylate, and then the following components were added successively: 1003 g of distilled water, 1452.2 g of acrylamide (50% by weight in water), 3.5 g of a commercially available silicone defoamer (Xiameter® AFE-0400), 10.5 g of a 5% aqueous solution of the pentasodium salt of diethylenetriamine-pentaacetic acid, 6.1 g of a 85% aqueous solution of the surfactant iC₁₃(CH₂CH₂O)₁₂H (Lutensol® TO129), 14 g of a 0.1 wt. % aqueous solution of sodium hypophosphite hydrate.

After adjustment to pH 6.4 with a 20% by weight solution of sulfuric acid, 6 g of an 87% aqueous solution of the macromonomer were added, the pH adjusted back to pH 6.4 and the rest of the water was added to attain the desired monomer concentration of 30% by weight (total amount of water 1071.3 g minus the amount of water already added, minus the amount of acid required), the monomer solution was adjusted to the initiation temperature of 0° C. The solution was transferred to a Dewar vessel, the temperature sensor for the temperature recording was inserted, and the flask was purged with nitrogen for 45 minutes. The polymerization was initiated with 10.5 g of a 10% aqueous solution of the water-soluble azo initiator 2,2′-azobis(2-methylpropionamidine) dihydrochloride (Wako V-50; 10h t_{1/2} in water 56° C.), 26.3 g of a 4% methanolic solution of the azo initiator azo-bis-(isobutyronitrile)dihydrochloride, 1.05 g of a 1% t-BHPO solution and 1.75 g of a 1% sodium sulfite solution. With the onset of the polymerization, the temperature rose to 87° C. within about 30 min. A solid polymer gel was obtained.

After the polymerization, the gel was incubated for 4 hours at Tₘₐₓ and the gel block was comminuted with the aid of a meat grinder. The comminuted aqueous polyacrylamide gel was kept for further testing without drying.

### Comparative example 6, Examples 6 to 8

The respective polymers were synthesized in the same manner as comparative example 5, except that the monomer concentration was lowered. The respective monomer concentration chosen as well as the test results are summarized in table 3.

TABLE 3
Test results

| | Concentration | | | | | | |
|---|---|---|---|---|---|---|---|
| | of monomers | | | | Mean | | Mean gel |
| | | DB | T₁ | T₂ | viscosity* | Mean | volume |
| No. | [wt. %] | [mol/kg] | [° C.] | [° C.] | [mPas] | MPFR | [ml] |
| C5 | 30.0 | 3.87 | 0 | 87 | 73 (1)* | 1.05 | 0 |
| C6 | 27 | 3.48 | 0 | 76 | 79 (1) | 1.03 | 0 |
| 6 | 25.5 | 3.29 | 0 | 70 | 94 (1) | 1.06 | 0 |
| 7 | 23 | 2.87 | 0 | 60 | 111 (2) | 1.04 | 0 |
| 8 | 20.5 | 2.64 | 0 | 50 | 137 (1) | 1.05 | 0 |

Viscosity measured at 5000 ppm in pH 7 buffer at RT, 100 s⁻¹.
MPFR measured at 1000 ppm in pH 7 buffer, 2 bar.
DB: double-bond number (moles reactive monomers per kg monomer mixture) The examples and comparative examples demonstrate that also for a chemically different polymer, the same effect is observed: The mean viscosity of the polymers increases as the concentration/T₂ decreases.

### Test Series 4 (Comparative Examples 7 to 9, Examples 9 and 10)

Test of copolymers comprising the same amount of acrylamide, Na-acrylate and macromonomer, however, polymerized at different concentrations. Aqueous solution additionally comprises a stabilizer.

Copolymer Comprising 69.5 wt. % (75.4 Mole %) of Acrylamide, 30.0 wt. % (24.6 Mole %) of Sodium-Acrylate and 0.5 wt. % (0.0154 Mole %) Macromonomer; Stabilized with 0.25% by Weight of Sodium-2-Mercaptobenzothiazole (NaMBT)

The polymers and comparative polymers were synthesized in the same manner as comparative example 5, except that 0.25% by weight of the stabilizer NaMBT was added, except that the monomer concentration was lowered. The respective monomer concentration chosen as well as the test results are summarized in table 4.

TABLE 4
Test results

| | Concentration | | | | | | |
|---|---|---|---|---|---|---|---|
| | of monomers | | | | Mean | | Mean gel |
| | | DB | T₁ | T₂ | viscosity* | Mean | volume |
| No. | [wt. %] | [mol/kg] | [° C.] | [° C.] | [mPas] | MPFR | [ml] |
| C7 | 30.0 | 3.87 | 0 | 88.9 | 60(1) | 1.12 | 0 |
| C8 | 27 | 3.54 | 0 | 74.2 | 75(1) | 1.04 | 0 |
| C9 | 26.5 | 3.41 | 0 | 71.1 | 78(2) | 1.07 | 0 |
| 9 | 24 | 3.09 | 0 | 62.3 | 94(2) | 1.08 | 0 |
| 10 | 21.5 | 2.77 | 0 | 52.9 | 103(3) | 1.06 | 0 |

Viscosity measured at 5000 ppm in pH 7 buffer at RT, 100 s⁻¹.
MPFR measured at 1000 ppm in pH 7 buffer, 2 bar.
DB: double-bond number (moles reactive monomers per kg monomer mixture)

The examples and comparative examples of series 4 again show the same characteristics. The mean viscosity of the polymers increases as the concentration/T₂ decreases.

### Test Series 5 (Comparative Examples 10 and 11, Example 11)

Test of copolymers comprising the same amount of acrylamide and macromonomer, however, polymerized at different concentrations.

### Comparative Example 10

### Synthesis of a Copolymer Comprising 98.0 wt. % (99.94 Mole %) of Acrylamide and 2.0 Wt. % (0.06 Mol %) of the Macromonomer

Monomer concentration: 3.65 mole/kg (27% by weight).

A 5 l beaker with magnetic stirrer, pH meter and thermometer was initially charged with 1600 g of distilled water. Following, 1780.28 g acrylamide (51% by weight in water), 3.5 g of a commercially available silicone defoamer (Xiameter® AFE-0400), 10.5 g of a 5% aqueous solution of the pentasodium salt of diethylenetriaminepentaacetic acid, and 21.8 g of a 85% aqueous solution of the surfactant iC3(CH2CH2)12H (Lutensol® TO 129) were added.

After adjustment to pH 6.0 with a 10% by weight solution of sulfuric acid, 21.3 g of an 87% aqueous solution of the macromonomer were added, the pH adjusted back to pH 6.0 and the rest of the water was added to attain the desired monomer concentration of 27% by weight (total amount of water 1666.1 g minus the amount of water already added, minus the amount of acid required). 21 g of a 10% aqueous solution of the water-soluble azo initiator 2,2′-azobis(2-methylpropionamidine) dihydrochloride (Wako V-50; 10h t½ in water 56° C.) was added and the monomer solution was adjusted to the initiation temperature of 0° C. The solution was transferred to a Dewar vessel, the temperature sensor for the temperature recording was inserted, and the flask was purged with nitrogen for 45 minutes. The polymerization was initiated with 1.75 g of a 1% t-BHPO solution and 3.5 g of a 1% sodium sulfite solution. With the onset of the polymerization, the temperature rose to 81° C. within about 25 min.

A solid polymer gel was obtained. After the polymerization, the gel was incubated for 4 hours at Tmax and the gel block was comminuted with the aid of a meat grinder. The comminuted aqueous polyacrylamide gel was dried in a fluid bed dryer and finally ground to a particle size <1 mm.

The polymerization conditions well as the test results are summarized in table 5.

### Comparative Example 11

### Synthesis of a Copolymer Comprising 98.0 wt. % (99.94 Mole %) of Acrylamide and 2.0 Wt. % (0.06 Mol %) of the Macromonomer

Monomer concentration: 3.38 mole/kg (25% by weight)

The copolymer was synthesized according to the same procedure as in comparative example 10, except that the concentration of the monomers was reduced from 27% by weight (3.65 mole/kg) to 25% by weight (3.38 mole/kg).

The polymerization conditions well as the test results are summarized in table 5.

### Example 11

### Synthesis of a Copolymer Comprising 98.0 wt. % (99.94 Mole %) of Acrylamide and 2.0 Wt. % (0.06 Mol %) of the Macromonomer.

Monomer concentration: 3.11 mole/kg (23% by weight).

The copolymer was synthesized according to the same procedure as in comparative example 10, except that the concentration of the monomers was reduced from 27% by weight (3.65 mole/kg) to 23% by weight (3.11 mole/kg).

### Tests:

In the test series 1 to 4 anionic polyacrylamides were tested. In test series 5 the polyacrylamides are uncharged. For that reason the test conditions were modified a bit.

No buffer was used but all tests were performed in a 1000 ppm solution of 1 mass % sodium chloride and 33.3 ppm of the surfactant iC₁₃O(CH₂CH₂O)₁₂H (Lutensol® TO 129) in deionized water.

A 3000 ppm stock solution was prepared by dissolving the appropriate amount of polyacrylamide and 100 ppm of the surfactant iC₁₃O(CH₂CH₂O)₁₂H (Lutensol® TO 129) under stirring overnight. For a final 1000 ppm polymer solution, the stock solution was diluted with the appropriate amount of 1 mass % NaCl, surfactant free solution, thereby yielding the abovementioned solution. Viscosity measurements were performed using an Anton Paar MCR 302 rheometer using a double gap geometry at 30° C. Aside from the different preparation of the samples, MPFR measurements, and gel fraction measurements were performed as described above.

The polymerization conditions well as the test results are summarized in table 5.

TABLE 5
Test results

| | Concentration | | | | | | |
|---|---|---|---|---|---|---|---|
| | of monomers | | | | Mean | | Mean gel |
| | | DB | T₁ | T₂ | viscosity* | Mean | volume |
| No. | [wt. %] | [mol/kg] | [° C.] | [° C.] | [mPas] | MPFR | [ml] |
| C10 | 27 | 3.65 | 0 | 81 | 6.3 | 1.06 | 0 |
| C11 | 25 | 3.38 | 0 | 74 | 11.2 | 1.03 | 0 |
| 3 | 23 | 3.11 | 0 | 66 | 56.1 | 1.00 | 0 |

Viscosity measured at 1000 ppm in 1% NaCl (including additional 33.3 ppm of the surfactant iC₁₃O(CH₂CH₂O)₁₂H (Lutensol ® TO 129)) solution at 30° C., 7 s⁻¹.
MPFR measured at 1000 ppm in 1% NaCl (including additional 33.3 ppm of the surfactant iC₁₃O(CH₂CH₂O)₁₂H (Lutensol ® TO 129)) solution, 2 bar, 5 μm (sieve mesh size).
DB: double-bond number (moles reactive monomers per kg monomer mixture)

Also the examples and comparative examples of test series 5 in which an uncharged polyacrylamide was tested show the same characteristics as the charged polyacrylamides in test series 1 to 4. The mean viscosity of the polymers increases as the concentration/T₂ decreases.

1. A process for producing hydrophobically associating polyacrylamides by radically polymerizing an aqueous solution comprising water-soluble, monoethylenically unsaturated monomers comprising at least
water,
40 mole % to 99.995 mole % of at least one monomer (A) selected from the group of (meth)acrylamide, N-methyl(meth)acrylamide, N,N′-dimethyl(meth)acrylamide or N-methylol(meth)acrylamide, wherein the amount relates to the total of all ethylenically unsaturated monomers in the aqueous solution, and
0.005 mole % to 1 mole % of at least one monoethylenically unsaturated monomer (B) selected from the group of
H₂C═C(R¹)—O—(—CH₂—CH(R²)—O—)ₖ—R³ (I),
H2C═C(R1)—(C═O)—O—(—CH2-CH(R2)—O-)k-R3 (II),
H₂C═C(R¹)—R⁴—O—(—CH₂—CH(R⁵)—O—)ₓ—(—CH₂—CH(R⁶)—O—)_{y}—(—CH₂—CH₂O—)_{z}—R⁷ (III),
wherein the amount relates to the total of all ethylenically unsaturated monomers in the aqueous solution, and
wherein the radicals and indices are defined as follows:
R¹: H or methyl;
R²: independently H, methyl or ethyl, with the proviso that at least 70 mol % of the R² radicals are H,
R³: aliphatic and/or aromatic, linear or branched hydrocarbyl radicals having 8 to 40 carbon atoms,
R⁴: a single bond or a divalent linking group selected from the group consisting of —(CₙH₂ₙ)—, —O—(C_{n′}H_{2n′})— and —C(O)—O—(C_{n″}H_{2n″})—, where n is a natural number from 1 to 6, and n′ and n″ are a natural number from 2 to 6,
R⁵: independently H, methyl or ethyl, with the proviso that at least 70 mol % of the R⁵ moieties are H,
R⁶: independently hydrocarbyl radicals of at least 2 carbon atoms,
R⁷: H or a hydrocarbyl radical having 1 to 30 carbon atoms,
k a number from 10 to 80,
x a number from 10 to 50,
y a number from 5 to 30, and
z a number from 0 to 10,
under adiabatic conditions in the presence of suitable initiators for radical polymerization thereby obtaining an aqueous polyacrylamide gel, wherein
the concentration of the monomers is from 1 mole/kg to 3.3 mole/kg, relating to the total of all components of the aqueous monomer solution,
the aqueous monomer solution has a temperature T₁ not exceeding 30° C. before the onset of polymerization, and
the temperature of the aqueous polyacrylamide gel T₂ after polymerization is from 45° C. to 80° C.

2. The process according to claim 1, wherein the concentration of the monomers is from 1.5 mole/kg to 3.3 mole/kg.

3. The process according to claim 1, wherein T₁ is from −5° C. to +20° C. and T₂ is from 50° C. to 70° C.

4. The process according to claim 1, wherein the monomer (B) is at least one monomer of the general formula (III).

5. The process according to claim 4, wherein the monomers (B) are a mixture comprising at least the following monomers:
H₂C═C(R1)-R4-O—(—CH2-CH(R5)—O-)x-(-CH2-CH(R6)—O-)y-H (IIIa) and
H₂C═C(R¹)—R⁴—O—(—CH₂—CH(R⁵)—O—)ₓ—(—CH₂—CH(R⁶)—O—)_{y}—(—CH₂—CH₂O—)_{z}—H (IIIb),
where the radicals and indices have the definition outlined above, with the proviso that, in the formula (IIIb), z is a number >0 to 10.

6. The process according to claim 5, wherein, in the formulae (IIIa) and (IIIb), R¹ is H, R⁴ is a —O—(C_{n′}H_{2n′})— group, R⁵ is H, R⁶ is ethyl, x is 20 to 30, y is 12 to 25, and z is 1 to 6.

7. The process according to claim 5, wherein, in the formulae (IIIa) and (IIIb), R¹ is H, R⁴ is —O—CH₂CH₂CH₂CH₂—, R⁵ is H, R⁶ is ethyl, x is 23 to 26, y is 14 to 18, and z is 3 to 5.

8. The process according to claim 1, wherein the aqueous solution comprises additionally up to 59.995 mol % of at least one water-soluble, monoethylenically unsaturated monomer (C) different from monomers (A) and (B).

9. The process according to claim 8, wherein monomer (C) comprises at least one acidic group selected from the group of —COOH, —SO₃H and —PO₃H₂ or salts thereof.

10. The process according to claim 9, wherein monomers (C) are selected from acrylic acid and/or ATBS or salts thereof.

11. The process according to claim 1, wherein the process comprises an additional step of drying the aqueous polyacrylamide gel.

12. The process according to claim 1, wherein the aqueous polyacrylamide gel is dissolved in an aqueous fluid, thereby obtaining an aqueous polyacrylamide solution.

13. Hydrophobically associating polyacrylamides obtainable by a process according to claim 1.

14. Use of hydrophobically associating polyacrylamides according to claim 13 for mining applications, oilfield applications, water treatment, waste water clean-up, paper making or agricultural applications.

15. Use of hydrophobically associating polyacrylamides according to claim 13 for producing mineral oil from underground mineral oil deposits by injecting an aqueous fluid comprising at least said hydrophobically associating polyacrylamides into a mineral oil deposit through at least one injection well and withdrawing crude oil from the deposit through at least one production well.

16. Use of hydrophobically associating polyacrylamides according to claim 13 for producing mineral oil from underground mineral oil deposits, comprising at least the steps of (i) blocking permeable regions of the underground mineral oil deposit by injecting an aqueous formulation into the formation through at least one well, said aqueous formulation comprising at least said hydrophobically associating polyacrylamides, and (ii) injecting an aqueous flooding medium into at least one injection well and withdrawing mineral oil through the at least one production well.

17. Use hydrophobically associating polyacrylamides according to claim 13 for fracturing subterranean formations by injecting an aqueous fracturing fluid comprising at least water, proppants and a friction reducer comprising at least said hydrophobically associating polyacrylamides through a wellbore into a subterranean formation at a pressure sufficient to flow into the formation and to initiate or extend fractures in the formation.
